(19) United States
(12) Patent Application Publication
(10) Pub. No.: US 2024/0274385 A1
(43) Pub. Date: Aug. 15, 2024

(54) SWITCHING ARRANGEMENT AND METHOD FOR OPERATING A SWITCHING ARRANGEMENT

(71) Applicant: EATON INTELLIGENT POWER LIMITED, Dublin (IE)

(72) Inventors: Gerd SCHMITZ, Niederkassel, NRW (DE); Wolfgang MEID, Mülheim-Kärlich, Rheinland-Plaz (DE); Marcel UEDELHOVEN, Blankenheim, NRW (DE)

(21) Appl. No.: 18/567,578

(22) PCT Filed: Jun. 8, 2022
(86) PCT No.: PCT/EP2022/025265

§ 371 Date: Dec. 6, 2023

(30) Foreign Application Priority Data
Jun. 9, 2021 (GB) 2108219.3

(51) Int. Cl. H01H 47/32; H01H 47/00; H01H 50/54

(52) U.S. Cl. CPC H01H 47/32; H01H 47/001; H01H 47/002; H01H 50/546

(57) ABSTRACT

A switching arrangement comprises a switching device with a contact bridge, a magnetic drive coupled to the contact bridge and a control circuit. The control circuit comprises a current sensing unit configured to measure a load current flowing through the switching device, a trigger level detector having an input coupled to an output of the current sensing unit, a reset circuit having an input coupled to an output of the trigger level detector, a timer having a reset input coupled to an output of the reset circuit and a driver having a control input coupled to an output of the timer. A terminal of the driver is coupled to a first terminal of the magnetic drive.

The present disclosure is related to a switching arrangement and a method for operating a switching arrangement.

A switching arrangement comprises a switching device. The switching device comprises e.g. a first and a second fixed contact, a contact bridge and a first and a second movable contact that are arranged at the contact bridge. The first fixed contact is in contact to the first movable contact and the second fixed contact is in contact to the second movable contact in a switched-on state of the switching device. The first fixed contact is free of a contact to the first movable contact and the second fixed contact is free of a contact to the second movable contact in a switched-off state of the switching device.

In an example, the switching device is configured for switching DC currents, especially higher DC currents. The switching arrangement may be used in the field of electric mobility.

Document WO 2020/016179 A1 describe a switching device and a switching arrangement being able to operate with higher currents.

Document US 2016/203932 A1 refers to a circuit breaker with a hybrid switch. An alternating current circuit breaker includes a bypass switch in a live line and a semiconductor switch connected parallel to the bypass switch. The semiconductor switch includes an insulated gate bipolar transistor, abbreviated IGBT. A current measurement unit includes a shunt resistor and is arranged in the live line. An output of the current measurement unit is coupled via a short circuit and overcurrent detection unit to a processing unit. The processing unit is coupled via a relay driver to a coil of the bypass switch and via a galvanic separation unit to the IGBT. The processing unit controls the bypass switch and the IGBT.

It is an object to provide a switching arrangement and a method for operating a switching arrangement being able to operate with an improved reaction in case of a high current.

These objects are achieved by the subject-matter of the independent claims. Further developments and embodiments are described in the dependent claims.

The definitions as described above also apply to the following description unless otherwise stated.

There is provided a switching arrangement that comprises a switching device with a contact bridge, a magnetic drive coupled to the contact bridge and a control circuit. The control circuit comprises a current sensing unit configured to measure a load current flowing through the switching device, a trigger level detector having an input coupled to an output of the current sensing unit, a reset circuit having an input coupled to an output of the trigger level detector, a timer having a reset input coupled to an output of the reset circuit and a driver having a control input coupled to an output of the timer. A terminal of the driver is coupled to a first terminal of the magnetic drive.

Advantageously, the current sensing unit is coupled to the timer via the trigger level detector and the reset circuit. Thus, in case of a load current over a predetermined limit, the timer is reset by a reset signal. The reset signal is generated by the reset circuit. After a reset of the timer, the timer does not continue to set the driver in such a state that magnetic drive moves the contact bridge in a switched-on state. Advantageously, a probability of contact bouncing or contact welding is reduced even in case of a connection to a non-precharged DC link or non-precharged capacitor to the switching arrangement.

In an embodiment of the switching arrangement, the trigger level detector is configured to detect whether a signal at the input of the trigger level detector is in a predetermined range. A signal at the input of the trigger level detector being in the predetermined range indicates that the load current is over the predetermined limit. Thus, the switching device has to be set in a switched-off state.

In an embodiment of the switching arrangement, the control circuit comprises a first input which is coupled to an input of the timer. A first signal is received at the first input. The first signal is e.g. one of a supply voltage or a logical signal.

In an embodiment of the switching arrangement, the timer is configured to start a pulse of a timer signal provided at the output of the timer when receiving an edge of a pulse at the input of the timer.

In an embodiment of the switching arrangement, the timer is configured to end the pulse of the timer signal when receiving an edge of a pulse at the reset input of the timer or after a predetermined time. Thus, the pulse of the timer signal is stopped in case a pulse is applied to the reset input of the timer. In case no pulse is applied to the reset input of the timer, the pulse of the timer signal is stopped after the predetermined time. The predetermined time may have a value in a range of 20 ms to 400 ms, alternatively in a range of 50 ms to 200 ms or alternatively in a range of 70 ms to 130 ms. In an example, a possible value of the predetermined time is 100 ms.

In an embodiment of the switching arrangement, the control circuit comprises a de-energizing unit that is coupled to a second terminal of the magnetic drive. The output of the trigger level detector is coupled via the reset circuit to a control input of the de-energizing unit.

In an embodiment of the switching arrangement, the driver is configured to control a first current that flows through the first terminal of the magnetic drive. The de-energizing unit is configured to control a second current that flows through the second terminal of the magnetic drive. The first current and the second current set an armature of the switching device in a switched-off position when the trigger level detector provides a pulse at the output of the trigger level detector.

In an embodiment of the switching arrangement, the control circuit comprises a further trigger level detector having an input coupled to the first input of the control circuit. An output of the further trigger level detector is coupled to the control input of the de-energizing unit.

In an embodiment of the switching arrangement, the further trigger level detector is configured to determine whether a signal at the input of the further trigger level detector is in a further predetermined range. A signal at the input of the further trigger level detector which is in the further predetermined range indicates that the switching device is to be set in the switched-off state. For example, the switching device is to be set in the switched-off state in case the first signal is a supply voltage having a low value or is a logical signal indicating to switch off the switching device.

In an embodiment of the switching arrangement, the reset circuit is configured to provide a further reset signal to the control input of the de-energizing unit. A pulse of the further reset signal has a predetermined duration. The predetermined duration is set such that de-energizing of the magnetic drive is achieved even in case the driver had provided a current to the magnetic drive up to an edge of the pulse. The predetermined duration of the pulse of the further reset signal is e.g. longer than a duration of a pulse of the trigger signal.

In an example, the further reset signal and the reset signal are identical. The output of the reset circuit that is coupled to the control input of the de-energizing unit is also coupled to the reset input of the timer.

In an alternative example, the further reset signal and the reset signal are different.

There is provided a method for operating a switching arrangement, comprising
measuring a load current that flows through a switching device by a current sensing unit,
generating a trigger signal by a trigger level detector as a function of a signal provided by the current sensing unit,
generating a reset signal by a reset circuit as a function of the trigger signal,
providing the reset signal to a reset input of a timer and
stopping a pulse of a timer signal which is generated by the timer and is provided to a driver at the point of time, when the trigger signal or the signal derived from the trigger signal is provided to the reset input of the timer, wherein the driver is coupled to a magnetic drive and the magnetic drive is coupled to a contact bridge of the switching device.

Advantageously, by stopping the pulse of the timer signal, the driver does not provide further energy to the magnetic drive.

The method for operating a switching arrangement may be implemented e.g. by the switching arrangement according to one of the embodiments defined above. Features described in connection with the switching arrangement can therefore be used for the method and vice versa.

In an embodiment, the method further comprises: generating a further reset signal with a pulse having a predetermined duration as a function of the trigger signal by the reset circuit, and providing the further reset signal to a de-energizing unit which is coupled to the magnetic drive. The de-energizing unit sets the switching device in a non-conducting state after receiving a pulse at its control input, e.g. after receiving the further reset signal.

In an example, the switching arrangement is configured as a bidirectional DC-protection device with weld-free opening in case of high current breaking. A risk of a contact welding of the switching device is reduced even in case of switching large, non-charged capacitors, e.g. in fact of a faulty pre-charging. The switching arrangement reduces the risk of welding.

In an example, on standard electrical switching devices, e.g. like a contactor, an unintended opening of the contacts could occur, caused by the magnetic field at the contact surfaces at a high current event, e.g. in the case of a short circuit. After the high current event, e.g. after breaking by an external fuse, the contacts are falling back to the closed position, back to the partially melted contact surfaces. This may result to a contact welding. A welding under short circuit events is avoided by the switching arrangement described herein, because the contactor is configured to open the contacts via the magnetic armature as fast enough to avoid a re-contacting after quenching of an arc.

In an example, a source of high current events could be caused by switching operations of large, non precharged capacitors, e.g. in a case of a faulty pre-charging circuit. In difference to a short circuit event, this results to very short current spikes at closing of the contact. The fast rise time of the current at first closing of the contact leads to a high current density at the contact point, with a very small melting area. The risk of a contact welding during the bouncing time is given and increases depending on the capacity of the switched capacitor and the value of the differential voltage. The switching device can be realized as contactor. A welding behavior could be reduced or fully avoided, because the switching device is configured to:
detect short charging spikes (normally in a range less than 300 μs),
compare the detection signal with a critical threshold,
interrupt the ongoing closing operation in case of an event and
discharge a coil of the magnetic drive in a very fast way. Thus, the movable contacts on the contact bridge are removed from the fixed contacts.

In an example, the switching arrangement is used in an arrangement configured to charge a capacitor which may be not precharged. This scenario refers to large, non-precharged capacitors. The capacitor is e.g. a so-called DC link capacitor in an electric vehicle. The capacitor usually has a capacitance e.g. of approximately 1000 μF to 2500 μF and is electrically directly connected to an electronic motor control in order to intercept or provide high pulse currents.

In an example, when starting an electric vehicle, the DC link capacitor is first precharged to avoid a very high inrush current. Without precharging, the inrush current can reach peak values of over 10 kA with a pulse width in the order of less than 100 μs. These currents are sufficient to melt a small area of the switching contact (the area may have the form of a point) when the switching device is switched on at a first contact of the movable contacts to the fixed contacts. The subsequent very rapid solidification of the melt in the range of a few milliseconds generally may result in a slight to very firm welding of the contacts in classic relays or contactors. This means that the electric motor of the vehicle can no longer be disconnected from the battery. This situation has to be avoided at all costs with regard to the required functional safety. The precharging of the capacitors is therefore generally already monitored with a high safety level. However, in the event of a fault, switching to a DC link capacitor that is not precharged cannot be avoided with absolute certainty. Therefore, to increase functional safety, the switching device described above and below is designed to reduce the probability of welding even in these exceptional cases.

In an example, a trigger point for detecting a non-operational load current, in this case a short-circuit current, may be identical with the detection of an impermissibly high inrush current. However, depending on the contact material and the restoring forces that determine the welding limit, it may also be necessary to set the threshold value for the inrush current lower. Another point is the pulse width of the current signal, which must be faster by a factor of about 10 to detect the inrush current (capacitive inrush ˜100 μs, short circuit <2 ms). Since the switching arrangement is typically not configured to detect the cause of a high current, the switching arrangement is designed for the “worst case scenario”. The switching arrangement has a detection time or response time e.g. less than 100 μs. Without the additional circuitry as described above and below, this would lead to the following: The capacitive inrush would briefly initiate a de-energization of the magnetic drive, but would not cause a switch-off due to the shortness of the peak of the inrush current; thus, the switch-on process of the drive solenoid would continue unaffected.

In an example, a switching device comprises a first and a second fixed contact, a contact bridge, and a first and a second movable contact that are arranged at the contact bridge. The first fixed contact is in contact to the first movable contact and the second fixed contact is in contact to the second movable contact in a switched-on state of the switching device. The first fixed contact is free of a contact to the first movable contact and the second fixed contact is free of a contact to the second movable contact in a switched-off state of the switching device. The switching device comprises a first terminal contact on which the first fixed contact is mounted and a second terminal contact on which the second fixed contact is mounted. A load current flows through the first terminal contact, first fixed contact, the first movable contact, the contact bridge, the second movable contact, the second fixed contact and the second terminal contact in the switched-on state.

Advantageously, the contact bridge is formed such that a high load current generates a magnetic field that improves a blowout of arcs at a transition from the switched-on state to the switched-off state. The load current has the curved path in a top view on the contact bridge.

In an example, the load current may be negative or positive. The load current may be e.g. a DC current and/or an AC current. Certain aspects of the present disclosure may not be applicable to an AC current embodiment, as will be understood.

In an example, the control circuit of the switching arrangement comprises an emergency input. The control circuit is configured to set the switching device in a switched-on state or in a switched-off state depending on a first signal provided to the first input. The control circuit is configured to set the switching device in a switched-off state depending on an emergency signal provided to the emergency input. Advantageously, the switching arrangement sets the switching device in the switched-off state in case of an emergency signal independent of the first signal. Thus, the switching arrangement can handle emergency cases and can be used also for higher load currents. The emergency signal blocks the first signal from setting the switching device in the switched-on state.

The switching arrangement may comprise the switching device as described above or another switching device. Thus, a load current that flows through the contact bridge between the first and the second movable contact in the switched-on state may have a curved path, a straight path or another path.

In an example, the current sensing unit of the control circuit measures the load current flowing through the switching device. The trigger level detector generates the trigger signal at its output. The control circuit is configured to set the switching device in a switched-off state as a function of the trigger signal.

In an example, the switching arrangement comprises a power bus with a first and a second terminal. The first terminal is connected via the switching device to the second terminal. The current sensing unit may measure the load current flowing through the first and/or second terminal. The first and the second terminal may be realized as first and second terminal lead or first and second connection line.

In an example, the switching arrangement comprises an auxiliary switch or auxiliary contacts. The magnetic drive is additionally coupled to the auxiliary switch or the auxiliary contacts. The auxiliary switch may be realized such as or similar to the switching device. For example, a common armature couples the magnetic drive to the contact bridge and to an auxiliary contact bridge of the auxiliary switch. The auxiliary contacts may e.g. use the contact bridge of the switching device.

In an example, the control circuit comprises a control detector that is connected to two terminals of the auxiliary switch or the auxiliary contacts. The control detector detects whether the auxiliary switch or the auxiliary contacts is set in a switched-on state or in a switched-off state. The control detector may generate an information about an actual state of the switching device based on the information about the state of the auxiliary switch or the auxiliary contacts. The control detector may generate an error signal in case of a deviation of a target state of the switching device and the actual state of the switching device.

In an example, the switching device combines a breaker and a relay. Electric vehicles and/or hybrid vehicles may use the switching device for conducting and switching of the regular operating currents of the electric propulsion or electric power drive and separate safety elements for fast switching in an emergency situation such as a crash or a short circuit. The switching device and the separate safety elements are used for current carrying and the safe isolation of the power supply between an energy storage and the supply system. These components are parts of a so-called high-voltage supply system on board and are configured e.g. for a nominal voltage of 400 V or higher.

In an example, the switching device is optionally realized as a remotely controlled and compact device. The switching device is designed for conducting a DC load current in the range above 100 A. The switching device is configured to switch the load current at a high voltage. A high voltage may be any voltage above 42 V, above 72 V, above 110 V, above 220 V, above 300 V, and/or above 360 V. During normal operation, sometimes named nominal rating, a power electronics of the vehicle limits a load current that has to be switched up to ca. 30 A, with a minimum number of switching operations of typically 100000. In case of an overload or short circuits at currents up to several kA, the switching device is configured only for a significantly lower number of switching operations.

The following description of figures of embodiments may further illustrate and explain aspects of the switching arrangement and of the method for operating a switching arrangement. Parts, devices and circuits with the same structure and the same effect, respectively, appear with equivalent reference symbols. In so far as parts, devices or circuits correspond to one another in terms of their function in different figures, the description thereof is not repeated for each of the following figures.

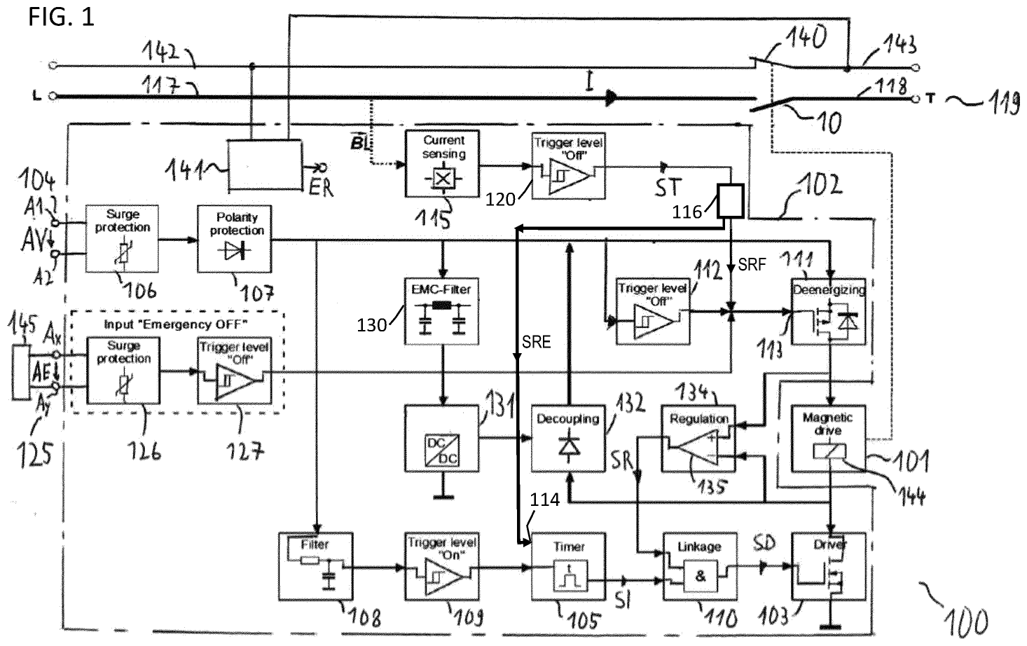

FIG. 1 shows an example of a switching arrangement, and

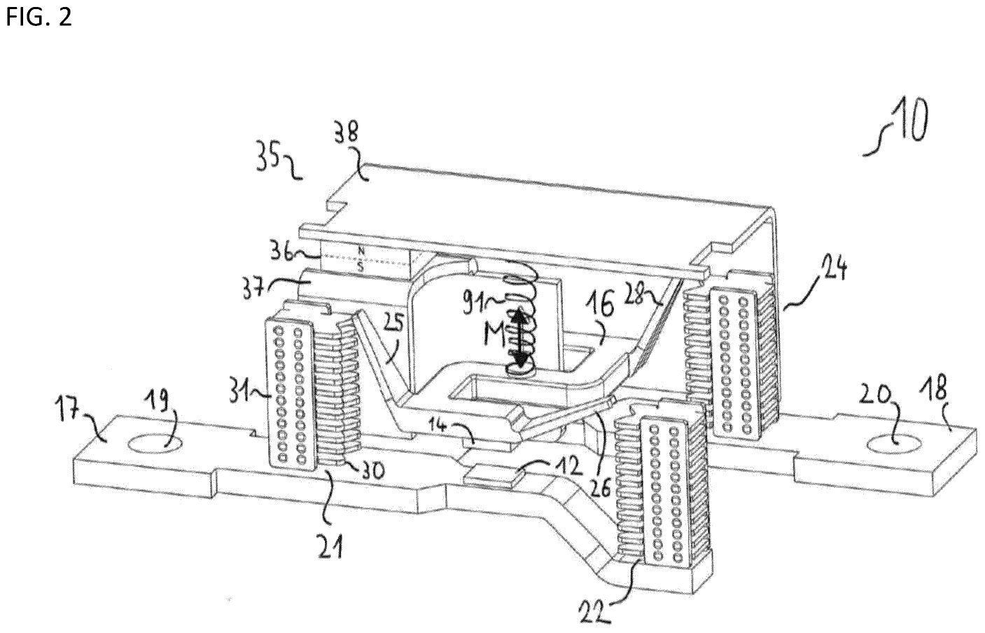

FIG. 2 shows an example of switching device.

FIG. 1 shows an example of a switching arrangement 100. The switching arrangement 100 may be named switching apparatus. The switching arrangement 100 comprises a switching device 10 indicated by the symbol of a switch. The switching device 10 is a mechanical switching device. The switching device 10 may be realized as shown in FIG. 2 or in another way. Moreover, the switching arrangement 100 comprises a magnetic drive 101 that generates a movement of a not shown armature, a contact bridge carrier and a contact bridge of the switching device 10. The switching device 10 is realized as a normally open device (NO device). Thus, in the case that no current flows through the magnetic drive 101, no magnetic field is generated by the magnetic drive 101 and the switching device is set in the switched-off state. A current flowing through the magnetic drive 101 generates a magnetic field and thus a movement of the armature that sets the switching device 10 in a switched-on state.

The switching arrangement 100 comprises a control circuit 102 that is coupled to the magnetic drive 101. The control circuit 102 controls the magnetic drive 101. A driver 103 of the control circuit 102 is coupled to a first terminal of the magnetic drive 101. The control circuit 102 comprises a first input 104. The first input 104 comprises two terminals A1, A2. A path between the first input 104 and the driver 103 comprises a timer 105. A first signal AV is provided to the first input 104. The first signal AV may have the form of a voltage, e.g. as a supply voltage. The first signal AV may be realized as a magnetic coil voltage. The magnetic coil voltage can be tapped between the two control terminals A1, A2. Additionally or alternatively, the first signal AV may be a logical signal, a command signal or a communication signal (e.g. from a network on a system), a virtual signal (e.g. a calculated voltage, state or other parameter utilized as the first input 104) or another physical signal such as an electrical signal of any type. In certain embodiments, either the presence of a signal, the absence of a signal or a value of the signal may be utilized as a first signal AV.

When the first signal AV indicates a voltage or a command that the switching device 10 has to be set in a switched-on state, the first signal AV is provided to the driver 103 via the timer 105. The timer 105 provides a timer signal SI having a pulse with a predetermined time which can be named predetermined turn-on time. The pulse of the timer signal SI at an output of the timer 105 is triggered by the first signal AV or a signal derived from the first signal AV and is provided during the predetermined turn-on time. The driver 103 provides a first current to the first terminal of the magnetic drive 101. The timer 105 temporarily limits the operation of the driver 103 which provides an inrush current to the magnetic drive 101 (which may be high); after that only the sealing current flows through the magnetic drive 101 (which may be significantly lower than the inrush current), as explained below. The inrush current is limited in its level and in its duration. The sealing current is lower than the inrush current.

The first input 104 is coupled via a surge protection unit 106, a polarity protection unit 107, a filter 108 and a first trigger level detector 109 to the timer 105. The polarity protection unit 107 provides safety against a reversed polarity of the first signal AV. The timer 105 is coupled via a control unit 110 to an input of the driver 103. The first trigger level detector 109 detects whether a signal at an input of the first trigger level detector 109 is in a predetermined voltage range; the predetermined voltage range indicates that the switching device 10 is to be set in the switched-on state. The trigger level detector 109 may be implemented as a comparator. The timer 105 is only triggered by the trigger level detector 109, if the first signal AV or the signal derived from the first signal AV is over a predetermined value. The predetermined value is set such that a safe transition between a switched-off state and a switched-on state can be performed. The filter 108 is implemented as low-pass filter. The trigger level detector 109 may be implemented as a Schmitt trigger circuit. Thus, the trigger level detector 109 may use a hysteresis.

Therefore, a flutter of the magnetic drive 101 is avoided. A signal provided by the trigger level detector 109 has an edge (e.g. a rising edge or a falling edge), when the first signal AV or the signal derived from the first signal AV rises over a predetermined value. The signal provided by the trigger level detector 109 may have the form of a pulse.

Moreover, the control circuit 102 comprises a de-energizing unit 111 that is coupled to a second terminal of the magnetic drive 101. The de-energizing unit 111 is realized e.g. as de-energizing circuit. The de-energizing unit 111 is configured to provide a second current to the magnetic drive 101 that quickly sets the armature of the switching device 10 in the switched-off position. Thus, the switching device 10 can be actively set in the switched-off state by the de-energizing unit 111. The first input 104 is coupled via the surge protection unit 106 and the polarity protection unit 107 to an input of the de-energizing unit 111 which may be a supply input. Moreover, the first input 104 is coupled via the surge protection unit 106, the polarity protection unit 107 and a further trigger level detector 112 to a control input 113 of the de-energizing unit 111.

The further trigger level detector 112 determines whether the signal at the input of the further trigger level detector 112 is in a further predetermined range indicating that the switching device 10 is to be set in the switched-off state. The further trigger level detector 112 may be realized as a comparator and/or Schmitt trigger circuit. A further predetermined value for switching-off may be e.g. 35% of the nominal value. The further trigger level detector 112 is configured not to react on short voltage drops, e.g. having a duration of a half of the mains period or less. If the further trigger level detector 112 detects that the first signal AV or a signal derived from the first signal AV is lower than the further predetermined value, the de-energization unit 111 is activated and the magnetic drive 101 is de-energized via a defined freewheeling voltage. Thus, a duration of the transition from the switched-on state to the switched-off state of the switching device 10 is constant. The duration may be independent from a present level of the first signal AV or a supply voltage and external circuits connected to the switching arrangement 100.

The driver 103 and the de-energizing unit 111 each comprise a transistor to control a current flowing through a magnetic drive coil 144 of the magnetic drive 101. A transistor of the driver 103 couples e.g. a reference potential terminal to the first terminal of the magnetic drive 101 and thus to a terminal of the magnetic drive coil 144. A transistor of the de-energizing unit 111 couples e.g. an output of the polarity protection unit 107 to the second terminal of the magnetic drive 101 and thus e.g. to a further terminal of the magnetic drive coil 144. The magnetic drive 101 also includes a magnet core. A current flowing through the magnetic drive coil 144 energizes the magnetic drive coil 144 such that the armature is pulled into the magnet core in order to close the magnetic flux circuit.

The switching arrangement 100 includes a switch-on operation, a hold operation and a switch-off operation. During the switch-on operation, the transistor of the driver 103 is set in a conductive state for approximately 100 ms. After 100 ms, the transistor of the driver 103 is set in a non-conductive state and a DC-to-DC converter 131 takes over the current generation for the hold operation. These two “current sources” are decoupled by a decoupling unit 132. The direction of current through the de-energizing unit 111 does not change. The de-energizing unit 111 comprises a Zener diode arranged in parallel to the transistor. During the switch-off operation, the transistor of de-energizing unit 111 is set in a non-conductive state and the Zener diode is connected in series to the magnetic drive coil 144.

Thus, the first signal AV at the first input 104 is configured to determine the current flowing through the magnetic drive 101. The control circuit 102 monitors whether the present level of the first signal AV should trigger switching-on or switching-off of the magnetic drive 101. Thus, the switching device 10 is either set in a switched-on state or in a switched-off state as a function of the first signal AV.

The control circuit 102 comprises a current sensing unit 115. The current sensing unit 115 is realized e.g. as current sensing circuit or current sensor. The current sensing unit 115 detects a value of a load current I flowing through the switching device 10. The current sensing unit 115 detects the value of the load current I flowing through a first or a second terminal lead 117, 118 of a power bus 119. The switching device 10 couples the first terminal lead 117 to the second terminal lead 118. The current sensing unit 115 may comprise at least a Hall sensor. Thus, the current sensing unit 115 detects a magnetic field BL generated by the load current I flowing through the power bus 119. The control circuit 102 comprises a reset circuit 116. The current sensing unit 115 is coupled via a trigger level detector 120 to an input of the reset circuit 116. Thus, the current sensing unit 115 is coupled via the trigger level detector 120 and the reset circuit 116 to the control input 113 of the de-energizing unit 111. The current sensing unit 115 is coupled via the trigger level detector 120 and the reset circuit 116 to a reset input 114 of the timer 105. A reset signal SRE is generated at the output of the reset circuit 116. The reset signal SRE is a function of the trigger signal ST. A pulse of the trigger signal ST triggers a change of the reset signal SRE. The reset circuit 116 comprises e.g. a transistor that sets the reset signal SRE to a ground value or reference potential in case a pulse is received by the reset circuit 116. A pulse of the reset signal ST has a predetermined duration. The predetermined duration of the pulse of the reset signal ST is e.g. longer than a pulse of the trigger signal ST. The reset circuit 116 has the function of a pulse defining circuit.

The trigger level detector 120 detects whether a signal at the input of the trigger level detector 120 is in a predetermined range indicating that the load current I is over a predetermined limit and thus the switching device 10 has to be set in the switched-off state. The predetermined range may be selected depending on operating conditions. In certain embodiments, operating conditions that may be utilized to select the predetermined range include, without limitation, a nominal power or power mode of the system, a request or command from the system indicating the present current limit to be enforced, an operating state of the system (e.g. “high power”, “economy”, and/or “quick charging”), and/or a diagnostic state or communicated limit of a component in the system (e.g. “failed”, “degraded”, a current limit, a temperature limit etc.). The trigger level detector 120 may be realized as a comparator and/or Schmitt trigger circuit. The trigger level detector 120 may be configured to compare the signal at the input of the trigger level detector 120 with more than one predetermined range. The trigger level detector 120 generates a trigger signal ST as a result of the comparison. The predetermined range may be selected by a set signal, not shown. A threshold or limit of a predetermined range may correspond for example to a load current I of 100 A, 200 A, 400 A, 1 kA (1000 Ampere), 1.5 kA, 3 kA, or 6 kA.

The current sensing unit 115 may comprise a Hall sensor element. The Hall sensor element detects a present value of the load current I and may optionally be designed for a switching-off procedure in the case of a short-circuit. When the load current I rises above a predetermined limit or threshold which may, for example, correspond to the multiple of the nominal current, the voltage of the magnetic drive coil 144 of the magnetic drive 101 will be switched off by the control circuit 102.

The timer signal SI is provided at the output of the timer 105. The timer 105 starts a pulse of the timer signal SI at the point of time, when an edge of a pulse is received at the input of the timer 105 (e.g. the edge is a rising edge). The pulse received at the input of the timer 105 is generated by the first trigger level detector 109 which receives the first signal AV or a signal derived from the first signal AV. The timer stops the pulse of the timer signal SI at the point of time when an edge of a pulse is received at the reset input 114 of the timer 105 (e.g. the edge is a falling edge). In case no pulse is received at the reset input 114 of the timer 105, the timer 105 stops the pulse of the timer signal SI after a predetermined time. The driver 105 only operates during the pulse of the timer signal SI. The predetermined time has a value e.g. of 100 ms. During the pulse of the timer signal SI a current flows through the magnetic drive coil 144 that is higher than a current which flows in a holding mode, holding phase or hold operation after the pulse of the timer signal SI. In an example, the contacts are closed at 25 ms. Thus, in case the load current I rises above the predetermined limit after the switching device 10 is set in the switched-on state e.g. after 25 ms, the driver 105 is instantly inactivated and set in a non-conducting state.

The control circuit 102 has an emergency input 125. The emergency input 125 is coupled via the de-energizing unit 111 to the magnetic drive 101. The emergency input 125 is coupled via a further surge protection unit 126 and an emergency trigger level detector 127 to the control input 113 of the de-energizing unit 111. The emergency trigger level detector 127 determines whether a signal at the input of the emergency trigger level detector 127 is in a predetermined range indicating that the switching device 10 has to be set in the switched-off state. The emergency trigger level detector 127 may be realized as a comparator and/or Schmitt trigger circuit. Thus, an emergency signal AE provided to the emergency input 125 indicates that the switching device 10 has to be set in the switched-off state. The emergency signal AE overrules the first signal AV. Thus, the switching device is set by the emergency signal AE in the switched-off state independent of the value of the first signal AV. The emergency input 125 has two terminals Ax, Ay. The emergency signal AE may have the form of a voltage. The emergency signal AE can be tapped between the two terminals Ax, Ay. Additionally or alternatively, the emergency signal AE may be a logical signal, a command signal or a communication signal (e.g. from a network on the system), a virtual signal (e.g. a calculated voltage, state or other parameter utilized as the emergency input 125) or another physical signal such as an electrical signal of any type. In certain embodiments, either the presence of a signal, the absence of a signal or a value of the signal may be utilized as an emergency signal AE. The control input 113 of the de-energizing unit 111 receives a signal that is a combination of a further reset signal SRF provided by the reset circuit 116, a signal provided by the further trigger level detector 112 and a signal provided by the emergency trigger level detector 127. The reset signal SRE and the further reset signal SRF may be identical or different. In an example, a predetermined duration of the pulse of the reset signal SRE is e.g. longer than a duration of a pulse of the trigger signal ST.

In an example, if during the tightening process (at the moment of contact closure of the main contacts) a short circuit or an excessive current is detected by the current sensing unit 115, caused e.g. by an uncharged DC link, the tightening process is interrupted via the feedback shown in the block diagram of FIG. 1 and the pulse duration is extended at the de-energizing unit 111 that realizes a fast de-energizing function. The pulse extension is advantageous because the energy during the tightening process is x times higher than in the holding mode of the switching device. This avoids welding of the main contacts. The current sensing unit 115 e.g. includes a Hall sensor. The tightening process can also be named switch-on operation.

An electric vehicle may comprise the switching arrangement 100. In the case of a critical operation situation such as, for example, in the case of a crash of the electric vehicle, the control circuit 102 performs an emergency off-function. The emergency signal AE realizes a trigger signal. The emergency signal AE is provided to the emergency input 125, for example in the case that an accelerometer or acceleration sensor 145 of the vehicle registers a crash. A crash or a short-circuit current result in an intermediate switching-off of the coil current and in a quick separation of the movable contacts 14, 15 from the fixed contacts 12, 13 of the switching device 10. Alternatively or additionally, the emergency signal AE may be generated at a maintenance event, an accident indicator, an emergency shutdown command, a vehicle controller request, a device protection request for some device on the vehicle, and/or a calculation that a temperature, voltage value or current value has exceeded a threshold.

Furthermore, the control circuit 102 comprises a filter 130 that couples the polarity protection unit 107 to a DC-to-DC converter 131 of the control circuit 102. The filter 130 is realized as an electro-magnetic compatibility filter, abbreviated EMC filter. The filter 130 reduces disturbances such as radio interferences that may be generated by the DC-to-DC converter 131 e.g. at the first input 104. The DC-to-DC converter 131 is realized as a stepdown converter. The DC-to-DC converter 131 provides a DC voltage at its output. In certain embodiments, the DC voltage is constant, but it is understood that the DC voltage may vary within nominal parameters, due to operating conditions, changes in the system over the life of the system (e.g. due to battery degradation and/or power electronics changes), and/or may be dependent upon the system including the switching arrangement 100. The DC voltage may be lower than the nominal voltage, e.g. 10% of the nominal voltage. A node between the magnetic drive 101 and the driver 103 is coupled via a decoupling unit 132 to a node between the polarity protection unit 107 and the de-energizing unit 111. An output of the DC-to-DC converter 131 is connected to an input of the decoupling unit 132. After the turn-on time provided by the timer 105, the magnetic drive 101 is powered by the DC-to-DC converter 131. The DC voltage is provided to the free-wheeling circuit of the magnetic drive 101. The DC voltage is configured as a holding voltage or sealing voltage. Thus, a high shock resistance is achieved even in case of a decrease of a supply voltage or the first signal AV, e.g. down to the value for switching-off.

Moreover, the control circuit 102 comprises a regulation unit 134 coupled on its input side to terminals of the magnetic drive 101. Thus, a first input of the regulation unit 134 is coupled to a node between the de-energizing unit 111 and a second terminal of the magnetic drive 101 and a second input of the regulation unit 134 is coupled to a node between a first terminal of the magnetic drive 101 and the driver 103. The regulation unit 134 comprises an amplifier 135. The regulation unit 134 may compare the voltage difference at the two inputs with a predetermined value. Thus, the regulation unit 134 may generate an output signal SR with a first logical value in the case that the voltage difference at the two inputs is higher than the predetermined value and may generate the output signal SR with a second logical value if the voltage difference at the two inputs is lower than the predetermined value. The regulation unit 134 is designed to determine a state of the magnetic drive 101. The regulation unit 134 has an output connected to an input of the control unit 110.

The control unit 110 is realized as a signal combiner and may be realized as a control logic. The control unit 110 provides a linkage between the signals SI, SR at the inputs of the control unit 110. Thus, the control unit 110 combines the output signal SR of the regulation unit 134 and the timer signal SI of the timer 105, for example by an AND-function.

The regulation unit 134 may generate the output signal SR depending on a comparison of the voltage difference at the two inputs and the predetermined value. The output signal SR may be an analog signal. The control unit 110 provides a driver signal SD to the driver 103. The driver signal SD may obtain different non-zero voltage values. The level of the driver signal SD depends on the value of the output signal SR of the regulation unit 134. The duration of the driver signal SD depends on the timer signal SI provided by the timer 105. Thus, the driver 103 only receives the driver signal SD to set the switching device 10 in a switched-on state, when the first signal AV indicates that the switching device 10 should be set in the switched-on state. During the transition from the switched-off state to the switched-on state of the switching device 10, the voltage across the magnetic drive 101 and thus at the coil 144 is hold on a constant predetermined value by a control loop. After the turn-on time provided by the timer 105, the driver 103 is switched off. Advantageously, the dynamic behavior of this transition is constant and independent of the present level of the first signal AV. A time for this transition is constant. The mechanical burden on the magnetic drive 101, a contact bounce and power consumption of the magnetic drive 101 are reduced.

The switching arrangement 100 comprises an auxiliary switch 140. The auxiliary switch 140 is coupled with the switching device 10. The contact bridge 16 of the switching device 10 is mechanically coupled with a movable contact of the auxiliary switch 140. The auxiliary switch 140 may comprise exactly one movable contact. The auxiliary switch 140 may be implemented as auxiliary contacts or replaced by auxiliary contacts.

The auxiliary switch 140 may also comprise a first and a second movable contact. In this case, the contact bridge 16 of the switching device 10 is coupled with the first and the second movable contact of the auxiliary switch 140. The auxiliary switch 140 comprises a pin or catch that couples the armature and the contact bridge 16 of the switching device 10 to the at least one movable contact of the auxiliary switch 140. The switching device 10 may be configured as a normally open device (NO device). In this case, the auxiliary switch 140 is configured as a normally closed device (NC device).

The control circuit 102 may comprise a control detector 141 that is connected to the two terminals of the auxiliary switch 140, e.g. by two further current lines 142, 143. The control detector 141 detects whether the auxiliary switch 140 is set in a switched-on state or in a switched-off state. When the control detector 141 detects that the auxiliary switch 140 is in a switched-on state and when the current sensing unit 115 detects that there is a non-zero load current I flowing through the switching device 10, then the control circuit 102 or the control detector 141 may generate an error signal ER. When the control detector 141 detects that the auxiliary switch 140 is in a switched-off state and when no current flows through the magnetic drive coil 144, then the control circuit 102 or the control detector 141 may generate the error signal ER. This may be the case, for example when the movable contacts 14, 15 of the switching device 10 cannot be separated from the fixed contacts 12, 13 of the switching device 10 due to a failure of the switching device 10.

The control circuit 102 can also be called control electronics. The control circuit 102 may have at least one of the following functions: The control circuit 102 is configured to provide a current to the magnetic drive coil 144 of the magnetic drive 101 above an input threshold voltage. The control circuit 102 is configured to reduce the current flowing through the magnetic drive coil 144 to a sealing current after the transition from the switched-off state to the switched-on state that means after forming an impulse of the armature. The timer 105 controls the reduction of the coil current to the value of the sealing current. The control circuit 102 is designed to switch off a voltage provided to the magnetic drive coil 144 in the case that a control voltage becomes less than a predetermined minimal control voltage. The control circuit 102 is configured to provide safety functions in the case of overvoltage or of a voltage peak.

When the load current I reaches the threshold current, the magnetic force holding the armature is switched off by the magnetic drive 101 by a quick de-energization of the magnetic drive coil 144. By the quick de-energization the acting magnetic force for closing is reduced to a value below the force of a contact spring as shown in FIG. 2 such that quick opening of the contact bridge is initiated. The contact spring is realized as a contact pressure spring. The contact spring primarily provides a contact pressure force on the closed contacts. One or more than one further springs (not shown) provide a forced separation of the armature and the magnet core. This or these springs may be realized as rejection pressure spring. This opening procedure can be tuned, improved, and/or optimized if the total moved mass of the system comprising the armature and the contact bridge 16 is provided at a selected value—for example by being constructively minimized. The mass of the contact bridge 16 is set such that a high velocity of opening is achieved. The switching device 10 may have a period for opening the contacts 12 to 15 less than 2 milliseconds, even in the case of nominal currents in the level of several hundred ampere. The period for opening is in the region of 10 ms or higher in the case of a conventional switching device. A fall-back of the contact bridge 16 in a closed state is inhibited by the early switching-off of the magnet drive 101 (e.g. even where the early switching-off does not result in the magnet drive 101 opening the contacts before the dynamic lift-off, due to reducing closing force at the time of opening, and continued reductions through the trajectory of the contact bridge 16 after opening), and by the resilience.

The switching device 10 is implemented as a remote-controlled DC switching device. The switching device 10 is fabricated as a compact device. The switching device 10 is configured to conduct and switch off bidirectional load currents and bidirectional overcurrents such as, for example, short-circuit currents. The switching device 10 has a short switch-off time for the safe switching-off of short-circuit currents. The time between the pulse of a switch-off signal up to the complete opening the contacts 12 to 15 is less than 2.5 ms. The switching device 10 uses an electromagnetic drive and an electronic rapid de-excitation.

The switching arrangement 100 comprises the current sensing unit 115 having a current sensor. The current sensor may be a Hall sensor element, although the current sensor may be any type of current sensing device including at least a virtual sensor that calculates the current through other information available in the system, a Rogowski coil, and/or measured magnetic characteristics from inductive properties in the system. The current sensor may be arranged in the vicinity of the first or the second terminal contact 17, 18 (shown in FIG. 2). The current sensing unit 115 is realized for the quick detection of a short-circuit current. The current sensing unit 115 detects the increase of a magnetic field when a short circuit is starting.

The switching arrangement 100 may be implemented in an electric or partially electric vehicle. The vehicle includes electrical storage (e.g. a battery) and an electric motor providing motive power for the vehicle. The power bus 119 having the switching device 10 couples the electrical energy storage to the electric motor. The switching device 10 combines a breaker and a relay. The switching arrangement 100 provides continuous (e.g. in the time domain, and also across a range of load current values) and selectable overcurrent protection above a critical current, while providing full rated operational current I to the vehicle motor. The switching arrangement 100 may be a hardware only device or may comprise a hardware and a controller using software. The switching arrangement 100 processes and/or handles the first signal AV and the emergency signal AE and responds via the control circuit 102 to perform selected operations such as to set the switching device 10 in a switched-on state or a switched-off state. The control circuit 102 may have a supply terminal for power supply of the control circuit or may receive its power via the first input 104. The switching device 10 may be switched off, when the first signal AV has the value 0 V.

FIG. 2 shows an example of a switching device 10 which is a further development of the switching device 10 explained above. The switching device 10 realizes a circuit breaker function and a drive function. In the following the breaker function is explained. The switching device 10 comprises a first and a second fixed contact 12, 13, a first and a second movable contact 14, 15 and a contact bridge 16. The contact bridge 16 may be named switching bridge. The first and the second movable contact 14, 15 are fixed on the contact bridge 16. The second fixed contact 13 and the second movable contact 15 are not shown in FIG. 2; they are covered behind other parts of the switching device 10 in this three-dimensional view. The contact bridge 16 directly connects the first movable contact 14 to the second movable contact 15.

Moreover, the switching device 10 comprises a first and a second terminal contact 17, 18. The first and the second terminal contact 17, 18 may be named first and second stationary contact piece, fixed contact piece or terminal contact piece. The first fixed contact 12 is directly fixed on the first terminal contact 17. The second fixed contact 13 is directly fixed on the second terminal contact 18. The first terminal contact 17 is connected e.g. to the first terminal lead 117 (shown in FIG. 1). The second terminal contact 18 is connected to the second terminal lead 118. A terminal lead can be realized as busbar or power cable.

The switching device 10 comprises a first pair of arc chambers 21, 22. The first pair of arc chambers 21, 22 is attached to the first terminal contact 17. Correspondingly, the switching device 10 comprises a second pair of arc chambers 23, 24. The second pair of arc chambers 23, 24 is fixed on the second terminal contact 18. Only one arc chamber 24 of the second pair can be seen in FIG. 2.

Additionally, the switching device 10 comprises a first pair of arc runners 25, 26 that is fixed at the contact bridge 16. The first pair of arc runners 25, 26 is attached to the contact bridge 16 in vicinity of the first movable contact 14. Correspondingly, the switching device 10 comprises a second pair of arc runners 27, 28. The second pair of arc runners 27, 28 is fixed to the contact bridge 16 in vicinity of the second movable contact 15. In FIG. 2 only one arc runner 28 of the second pair of arc runners can be seen.

Additionally, the switching device 10 comprises a permanent magnet system 35 that comprises a permanent magnet 36. The permanent magnet 36 is realized e.g. as a rectangular cuboid. The permanent magnet 36 may be realized using a ferromagnetic material, a ferrite or a rare earth magnetic material. Moreover, the permanent magnet system 35 comprises an inner pole plate 37 and an outer pole plate 38. The inner and the outer pole plates 37, 38 have a U-shape form. The permanent magnet 36 is arranged between the inner pole plate 37 and the outer pole plate 38. Thus, the inner pole plate 37 may be a south pole plate and the outer pole plate 38 may be realized as a north pole plate. The outer pole plate 38 has the form of a rectangle before the outer pole plate 38 is bended in the U-shape. Correspondingly, the inner pole plate 37 has the form of a rectangular sheet before it is bended to realize the U-shape. The inner and the outer pole plates 37, 38 have openings. For example, the inner pole plate 37 has openings to allow a placement and a movement of the contact bridge 16. The switching device 10 comprises a contact spring 91 that couples a contact bridge carrier to the contact bridge 16 or couples the armature to the contact bridge carrier.

The switching device 10 is set from the switched-off state into the switched-on state by a movement of the contact bridge 16 in a direction perpendicular to the contact bridge 16. The magnetic drive 101, as shown in FIG. 1, moves the contact bridge 16 towards the first and the second terminal contact 17, 18. In the switched-on state, the first fixed contact 12 is in contact to the first movable contact 14 and the second fixed contact 13 is in contact to the second movable contact 15. Thus, a load current I can flow from the first terminal contact 17 via the first fixed contact 12, the first movable contact 14, the contact bridge 16, the second movable contact 15 and the second fixed contact 13 to the second terminal contact 18. The load current I that flows through the contact bridge 16 has a curved path. As shown in FIG. 2, the contact bridge 16 has as an S-shaped form or a meander form. The form is seen in the top view on the contact bridge 16. In different examples, the contact bridge 16 has a form of a group consisting of a U-shape, C-shape, S-shape, a zig-zag, a meander, a Z-shape, two connected semicircles and a form twice curved in opposite directions.

The switching device 10 is set from the switched-on state into the switched-off state by a movement of the contact bridge 16 that separates the contact bridge 16 from the first and the second terminal contacts 17, 18. In case of a load current I flowing before switching, a first arc is generated between the first fixed contact 12 and the first movable contact 14 and a second arc is generated between the second movable contact 15 and the second fixed contact 13. The first arc is driven in one of the arc chambers 21, 22 of the first pair of arc chambers depending on the direction of the load current I. Correspondingly, the second arc is driven in one of the arc chambers 23, 24 of the second pair of arc chambers depending on the direction of the load current I.

The movement of the first arc into one of the arc chambers 21, 22 is caused by a magnetic field at the place of the first arc. The magnetic field is generated by the permanent magnet system 35 and by different sections of the path of the load current I, for example the flow of the load current I in a first outer part of the contact bridge 16 that is connected to the first movable contact 14 and by the load current I flowing through the first terminal contact 17. The first arc between the first fixed contact 12 and the first movable contact 14, the first terminal contact 17, and the first outer part of the contact bridge 16 forms a first magnetic field loop, also called first magnetic blowout field loop. In the case of a short circuit, the first magnetic field loop has a magnetic blow effect on the first arc in the direction of one arc chamber of the first pair of arc chambers 21, 22. The second arc is moved in a corresponding manner. These two arcs are generated in the case of opening the contacts 12 to under load.

The methods, procedures, systems, and arrangements described herein may be deployed in part or in whole through a machine having one or more computing devices such as a computer, controller, processor, and/or circuit that executes computer readable instructions, program codes, instructions, and/or includes hardware configured to functionally execute one or more operations of the methods and systems herein. The terms computer, controller, processor, and/or circuit, as utilized herein, should be understood broadly.

At least one of the units 106, 107, 110, 111, 115, 126, 132, 134 mentioned above can be named circuit, module or block.

The embodiments shown in FIGS. 1 and 2 as stated represent examples of the improved switching arrangement and method; therefore, they do not constitute a complete list of all embodiments according to the improved switching arrangement and method. Actual switching arrangements or methods may vary from the embodiments shown in terms of parts, structures, steps and shape, for example.

### REFERENCE NUMERALS

10 switching device
12 first fixed contact
13 second fixed contact
14 first movable contact
15 second movable contact
16 contact bridge
17 first terminal contact
18 second terminal contact
19, 20 terminal connection hole
21 to 24 arc chamber
25 to 28 arc runner
30 splitter plate
35 permanent magnet system
36 permanent magnet
37 inner pole plate
38 outer pole plate
91 contact spring
100 switching arrangement
101 magnetic drive
102 control circuit
103 driver
104 first input
105 timer
106, 126 surge protection unit
107 polarity protection unit
108, 130 filter
109 first trigger level detector
110 control unit
111 de-energizing unit
112 further trigger level detector
113 control input
114 reset input
115 current sensing unit
116 reset circuit
117, 118 terminal lead
119 power bus
120 trigger level detector
125 emergency input
127 emergency trigger level detector
130 filter
131 DC-to-DC converter
132 decoupling unit
134 regulation unit
135 amplifier
140 auxiliary switch
141 control detector
142, 143 further current line
144 magnetic drive coil
145 acceleration sensor
AV first signal
AE emergency signal
BL magnetic field
ER error signal
I load current
SD driver signal
SI timer signal
SR output signal
SRE reset signal
SRF further reset signal
ST trigger signal

1. A switching arrangement, comprising:
a switching device,
a magnetic drive; and,
a control circuit,
wherein the control circuit comprises:
a current sensing unit configured to measure a load current flowing through the switching device,
a trigger level detector having an input coupled to an output of the current sensing unit,
a reset circuit having an input coupled to an output of the trigger level detector; and,
a driver having a control input, wherein a terminal of the driver is coupled to a first terminal of the magnetic drive, wherein
that the switching device comprises a contact bridge,
wherein the magnetic drive is coupled to the contact bridge,
wherein the control circuit comprises a timer having a reset input coupled to an output of the reset circuit, and
wherein a control input of the driver is coupled to an output of the timer.

2. The switching arrangement of claim 1,
wherein the trigger level detector is configured to detect whether a signal at the input of the trigger level detector is in a predetermined range.

3. The switching arrangement of claim 1,
wherein the control circuit comprises a first input which is coupled to an input of the timer.

4. The switching arrangement of claim 3,
wherein the timer is configured:
to start a pulse of a timer signal provided at the output of the timer when receiving an edge of a pulse at the input of the timer; and,
to end the pulse of the timer signal when receiving an edge of a pulse at the reset input of the timer or after a predetermined time.

5. The switching arrangement of claim 1,
wherein the control circuit comprises a de-energizing unit that is coupled to a second terminal of the magnetic drive; and,
wherein the output of the trigger level detector is coupled via the reset circuit to a control input of the de-energizing unit.

6. The switching arrangement of claim 5,
wherein the driver is configured to control a first current that flows through the first terminal of the magnetic drive,
wherein the de-energizing unit is configured to control a second current that flows through the second terminal of the magnetic drive; and,
wherein the first current and the second current set an armature of the switching device in a switched-off position when the trigger level detector provides a pulse at the output of the trigger level detector.

7. The switching arrangement of claim 5,
wherein the control circuit comprises a further trigger level detector having an input coupled to a first input of the control circuit; and,
wherein an output of the further trigger level detector is coupled to the control input of the de-energizing unit.

8. The switching arrangement of claim 7,
wherein the further trigger level detector is configured to determine whether a signal at the input of the further trigger level detector is in a further predetermined range.

9. The switching arrangement of claim 5,
wherein the reset circuit is configured to provide a further reset signal with a pulse having a predetermined duration to the control input of the de-energizing unit.

10. A method for operating a switching arrangement, comprising:
measuring a load current that flows through a switching device by a current sensing unit,
generating a trigger signal by a trigger level detector as a function of a signal provided by the current sensing unit,
generating a reset signal by a reset circuit as a function of the trigger signal,
providing the reset signal to a reset input of a timer; and,
stopping a pulse of a timer signal which is generated by the timer and is provided to a driver at the point of time, when the trigger signal or the signal derived from the trigger signal is provided to the reset input of the timer, wherein the driver is coupled to a magnetic drive and the magnetic drive is coupled to a contact bridge of the switching device.

11. The method of claim 10,
wherein the method further comprises:
generating a further reset signal with a pulse having a predetermined duration as a function of the trigger signal by the reset circuit; and
providing the further reset signal to a de-energizing unit which is coupled to the magnetic drive.
